(19) United States
(12) Patent Application Publication
(10) Pub. No.: US 2015/0062054 A1
(43) Pub. Date: Mar. 5, 2015

(54) TOUCH ELECTRODE PATTERN, TOUCH PANEL, AND TOUCH INPUT DEVICE INCLUDING THE SAME

(71) Applicant: Zinitix Co., Ltd., Daejeon (KR)

(72) Inventors: Il-Hyun Yun, Daejeon (KR); Tai Hyun Yoon, Daejeon (KR)

(73) Assignee: Zinitix Co., Ltd., Daejeon (KR)

(21) Appl. No.: 13/989,469

(22) PCT Filed: Dec. 21, 2012
(86) PCT No.: PCT/KR2012/011308

§ 371 Date: May 24, 2013

(30) Foreign Application Priority Data
Dec. 13, 2012 (KR) 2012-0145833

(51) Int. Cl. G06F 3/044; G06F 3/041

(52) U.S. Cl. CPC G06F 3/044; G06F 3/0412
USPC 345/174

(57) ABSTRACT

A touch panel is disclosed. The touch panel comprises a driving electrode including a plurality of driving electrode-cells and a sensing electrode including a plurality of sensing electrode-cells. The driving electrode and the sensing electrode are formed in the same layer of the touch panel. Each of the sensing electrode-cells is configured to envelop up-down-left-right side of a driving electrode-cell which is electrically coupled to the each of the sensing electrode-cells. And a slit is formed at each of the sensing electrode-cells for connecting a driving trace to the driving electrode-cell.

### TECHNICAL FIELD

The present invention relates to a touch electrode pattern, a touch panel and a touch input device using the touch electrode pattern.

### BACKGROUND ART

A touch input device is an input device which is capable of sensing the location (i.e. coordinate) of an input means such as a finger, and provides information regarding the sensed location. Typically, a resistive method or a capacitive method is used for a touch input device. A capacitive method can be classified into a self-capacitive method and a mutual-capacitive method. For a mutual-capacitive method, driving electrodes and sensing electrodes are made of transparent conductive material. Typically, the extended direction of a driving electrode is different from that of a sensing electrode, and in a particular implementation, the extended directions are perpendicular to each other.

Capacitance can be formed between a driving electrode and a sensing electrode, especially in the intersecting area of driving and sensing electrodes. This intersecting area may be referred to as a ‘touch node’ or a ‘node’ in this document. In a touch panel, one or more driving electrodes and one or more sensing electrodes are provided, thus one or more touch nodes can be provided.

When a finger is touched on or in the proximity of a touch node, the value of the capacitance between the sensing electrode and the driving electrode for the touch node is changed. Accordingly, whether a finger is touching the touch panel or not can be determined by measuring the change of the capacitance between the sensing and driving electrodes.

When electric current is applied to a particular driving electrode in order to measure the change of capacitance by sensing and driving electrodes, electrons are injected to N (N≧=1) sensing electrodes which are crossed over the particular driving electrode. The amount of electrons injected into each of the N sensing electrodes may be different each other according to the capacitance value formed by the particular driving electrode and each of the N sensing electrodes. Thus, by measuring and comparing the amount of the electrons injected into the N sensing electrodes, among the N touch nodes formed by the particular driving electrode and the N sensing electrodes, the touch input location as well as whether any touch node is touched or not can be determined. This process can be performed for a plurality of driving electrodes sequentially or simultaneously and the location where a touch input is provided can be determined over a whole touch panel.

### DISCLOSURE

### Technical Problem

A touch node has a predefined surface area A1, and the center point of the touch node may be referred to as a ‘node center point’ in this specification. Meanwhile, when an input device such as a finger is touched on a touch panel, a contact surface with a certain area A2 can be defined. In this case, the center point of the contact surface may be referred to as a ‘touch center point’ in this specification. The amount of the area of a part of a touch node which is covered by the input device, can change according to the distance from a touch center point to a node center point. In result, the capacitance of a touch node changes according to the distance d from a touch center point and a node center point. Here, a technical problem that the calculation complexity for determining a touch input location increases unless the amount of the change (ΔC) of the capacitance of a touch node increases or decreases with the distance in linear manner.

In addition, for the case that the first pattern shape along a first direction (e.g. x-axis direction) is not substantially the same as the second pattern shape along a second direction (e.g. y-axis direction) within a touch node, a problem arises that the touch characteristic along the first direction within the touch node can be different from that along the second direction within the touch node.

When a touch center point is located on the border line between a first touch node and a second touch node adjacent to the first touch node, it is desired that the amount of capacitance change of the first touch node is the same as that of the second touch node. However, in case that the patterns of the two touch nodes are not symmetric with an axis of the border line, the amount of capacitance change of the first touch node is not the same as that of the second touch node. Due to the problems above, calculation accuracy for locating a touch input point decreases. In particular, the touch input characteristic for a first drag mode, for which a fingertip touched on a touch panel is dragged from the left to the right, is different from that for a second drag mode, for which the fingertip touched on a touch panel is dragged from the right to the left.

The present invention is directed to a new structure of sensing and driving electrodes which enables the capacitance of a particular touch node to change in a substantially linear manner according to the coordinate of a touch input location when a touch input is provided on a touch panel of which sensing electrodes and driving electrodes are formed on the same layer. In addition, the present invention is directed to a structure of sensing and driving electrodes which enables that the sensing characteristic of touch inputs along the y-direction is substantially the same as that along the x-direction. In addition, the present invention is directed to a structure of sensing and driving electrodes which minimizes the difference between capacitance changes of adjacent two touch nodes when a touch center point is located on the border line of the two touch nodes.

### Technical Solution

A touch panel in accordance with one aspect of the present invention comprises a driving electrode including a plurality of driving electrode-cells and a sensing electrode including a plurality of sensing electrode-cells. The driving electrode and the sensing electrode are formed in the same layer of the touch panel. Each the sensing electrode-cells is configured to envelop up-down-left-right side of a driving electrode-cell which is electrically coupled to the each of the sensing electrode-cells, and a slit is formed at the each of the sensing electrode-cells for connecting a driving trace to the driving electrode-cell.

The driving electrode-cell itself may have a up-down-left-right symmetric shape, and the sensing electrode-cell itself may have a up-down-left-right symmetric shape except the slit.

The driving electrode-cell may have a first whirling portion extended along a first sense of rotation, and the sensing electrode-cell may include a second whirling portion which is extended along the first sense of rotation.

The [k]-th slit formed at the [k]-th sensing electrode-cell included in the sensing electrode may be formed at left side of the [k]-th sensing electrode-cell, and the [k+1]-th slit formed at the [k+1]-th sensing electrode-cell included in the sensing electrode may be formed at right side of the [k+1]-th sensing electrode-cell.

All of the plurality of slits formed at a plurality of sensing electrode-cells included in the sensing electrode may be formed at one side of the plurality of the sensing electrode-cells.

A touch panel in accordance with another aspect of the present invention comprises a plurality of touch nodes disposed in a matrix form. Each of the touch node includes a driving electrode-cell and a sensing electrode-cell which is electrically coupled to the driving electrode-cell. The driving electrode-cell and the sensing electrode-cell are formed at the same layer of the touch panel. The sensing electrode-cell in the touch node is configured to envelop up-down-left-right side of a driving electrode-cell which is electrically coupled to the sensing electrode-cell, and a slit is formed at the sensing electrode-cell for connecting a driving trace to the driving electrode-cell.

The driving electrode-cell itself may have a up-down-left-right symmetric shape, and the sensing electrode-cell itself may have a up-down-left-right symmetric shape except the slit.

A touch panel in accordance with still another aspect of the present invention comprises a driving electrode and a sensing electrode. The driving electrode and the sensing electrode are formed on the same layer of the touch panel. The sensing electrode has a ladder shape. A driving electrode-cell which is electrically coupled to the sensing electrode is enveloped up-down-left-right side with the sensing electrode. And a slit is formed at the sensing electrode to pass a driving trace connected to the driving electrode-cell.

### Advantageous Effects

Using the sensing and driving electrodes with a new pattern according to one embodiment of the present invention, the amount of capacitance change of a touch node in a touch panel can change more linearly with the coordinate of a touch input point. In addition, with the sensing and driving electrodes according to one embodiment of the present invention, a touch input characteristic along the x-axis becomes substantially the same as that along the y-axis. In addition, with the sensing and driving electrodes according to one embodiment of the present invention, when a touch center point is located on the border line between two adjacent sensing electrodes, the difference between capacitance changes of the two adjacent sensing electrodes can decrease.

### DESCRIPTION OF DRAWINGS

FIG. 1a and FIG. 1b are to explain the operation principle of a touch panel of which sensing electrodes 120 and driving electrodes 110 are formed on the same layer.

FIG. 2a to FIG. 2c is to explain the capacitance change according to the location of the touch center point of a touch node of a touch panel.

FIG. 3 illustrates a touch panel according to one embodiment.

FIG. 4a and FIG. 4b are to explain the asymmetric characteristic of the touch input for a touch input gesture.

FIG. 5a is to explain the principle to form patterns for a sensing electrode-cell 200 and a driving electrode-cell 210 according to embodiments of the present invention.

FIG. 5b is to explain the shape and location of sensing electrode-cells 200, driving electrode-cells 210, and driving traces 22 according to one embodiment of the present invention.

FIG. 5c illustrates an example modified from the pattern shown in FIG. 5b, where the slits SL formed at sensing electrode-cells 200, which are vertically adjacent to each other, are formed only at the right side of the sensing electrode-cells.

FIG. 5d shows another example modified from the pattern illustrated in FIG. 5b.

FIG. 6a to FIG. 6d illustrates various shapes of a touch node according to various embodiments of the present invention.

FIG. 7a shows a structure of a touch panel according to one embodiment of the present invention.

FIG. 7b illustrates a modified embodiment where the elements corresponding to the conductive lines 111 of FIG. 7a are omitted and the sensing electrode-cells are disposed very closely to be connected to each other in vertical direction.

FIG. 7c shows a modified embodiment where the patterns of the touch nodes included in the second row R2 and the fourth row R4 of the touch panel shown in FIG. 7b are flipped horizontally.

FIG. 7d shows an embodiment modified from FIG. 7a such that each touch node of the touch panel shown in FIG. 7a is substituted by the touch node shown in FIG. 6d.

FIG. 7e shows an embodiment modified from FIG. 7b such that each touch node of the touch panel shown in FIG. 7b is substituted by the touch node shown in FIG. 6d.

FIG. 7f shows an embodiment modified from FIG. 7c such that each touch node of the touch panel shown in FIG. 7c is substituted by the touch node shown in FIG. 6d.

FIG. 7g shows an embodiment modified from FIG. 7d such that the touch nodes of the second column C2 and the fourth column C4 of the touch panel shown in FIG. 7d are flipped over in the vertical and horizontal direction.

FIG. 8 shows a connection relationship of the driving traces 11 and the sensing traces 12 shown in FIG. 7a at the area out of the sensing area of the touch panel.

### MODE FOR INVENTION

A detailed description for the embodiments of the present invention will now be made below with reference to the accompanying drawings so that the present invention can be easily implemented by one skilled in the art. The present invention may be implemented in various ways, and is not restricted to the embodiments explained in this specification. The terms used in this specification are to explain some embodiments, and are not intended to restrict the scope of the present invention. In addition, any term in singular form may include the meaning for plural form. Some part of the accompanying drawings may be exaggerated, up-scaled, or down-scaled for the convenience of explanation.

A touch panel according to one embodiment of the present invention includes a plurality of transparent electrodes which are extended along a first direction (e.g. vertical direction). In addition, the touch panel includes a plurality of transparent electrodes which are extended along a second direction (e.g. horizontal direction). Here, the first direction and the second direction may be perpendicular to each other, but the present invention is not limited to the crossing angle. In this specification, an electrode which is extended along the vertical direction may be referred to as a sensing electrode, and an electrode which is extended along the horizontal direction may be referred to as a driving electrode. But, in other embodiments, the role of a vertically extended electrode and the role of a horizontally extended electrode can be interchanged.

Sensing electrodes and driving electrodes may be formed on different layers or on the same layer in a touch panel. A cross-section area of a sensing electrode and a driving electrode can be defined, and the cross-section areas formed by a plurality of sensing electrodes and driving electrodes can have a matrix structure. The area corresponding to each element of the matrix structure can be considered as a basic unit to determine touch input location in a touch panel. Such a basic unit can be referred to as a ‘touch node’ or just a ‘node’ in this specification.

If a voltage is applied to a driving electrode, a plurality of charges can be injected into the driving electrode and a sensing electrode which is electrically coupled with the driving electrode at the intersection area of the driving and sensing electrode. The amount of electrons inputted into each sensing electrode, Qₛₑₙₛₑ, can be calculated as a multiple of the mutual capacitance Qₛₑₙₛₑ by a first voltage level of a driving signal applied to the driving electrode (Qₛₑₙₛₑ=V_{drive}*Cₛₑₙₛₑ).

During a particular time interval, a driving signal such as a pulse train signal can be applied to a selected driving electrode among a plurality of electrodes in a touch panel, where a first level of voltage and a second level of voltage are periodically repeated in turn in the pulse train signal. After the particular time interval is over, the driving signal may be applied to another selected driving electrode among the plurality of electrodes. To the remaining driving electrodes except the selected one driving electrode, a direct constant voltage such as ground (0) voltage can be applied. However, in other embodiments, a configuration can be adopted where a driving signal is commonly applied to a plurality of driving electrodes at the same time.

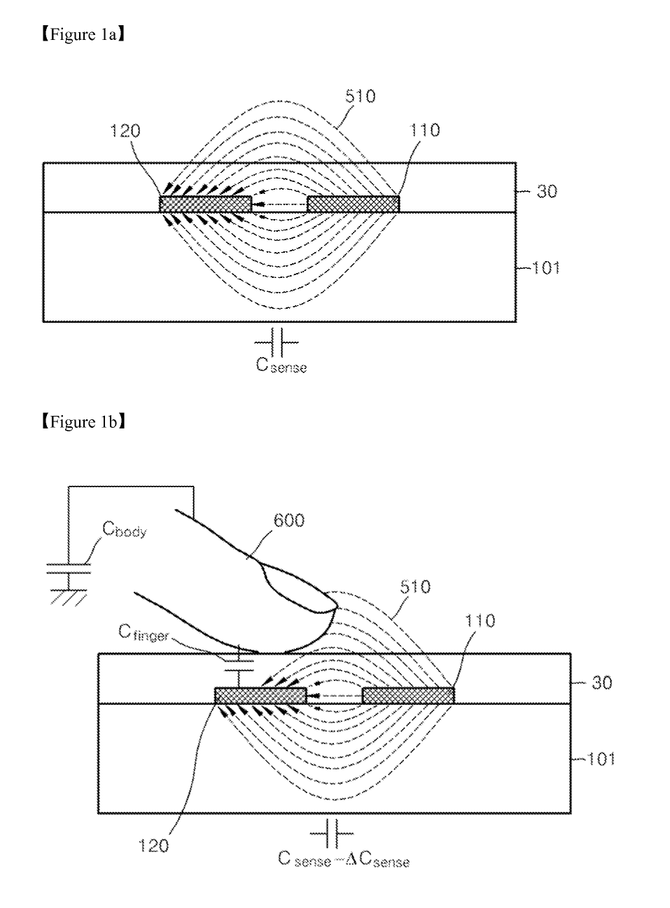

FIG. 1a and FIG. 1b are to explain the operation principle of a touch panel of which sensing electrodes 120 and driving electrodes 110 are formed on the same layer. As shown in FIG. 1b, when a touch input is provided by the fingertip 600, as a portion of the electric field 120 originated from the driving electrode 110 is screened by the fingertip 600, the mutual capacitance by the driving electrode 110 and the sensing electrode 120 can change from Cₛₑₙₛₑ to Cₛₑₙₛₑ−ΔCₛₑₙₛₑ. If the dynamic range of the mutual capacitance change by a touch input gets larger, determining whether a touch input is provided or not gets easier. Therefore, it is desired that the sensing electrode 120 and driving electrode 110 have such a shape which can provide enough electric fields 510 that can be screened/covered or absorbed by a touch device such as a fingertip.

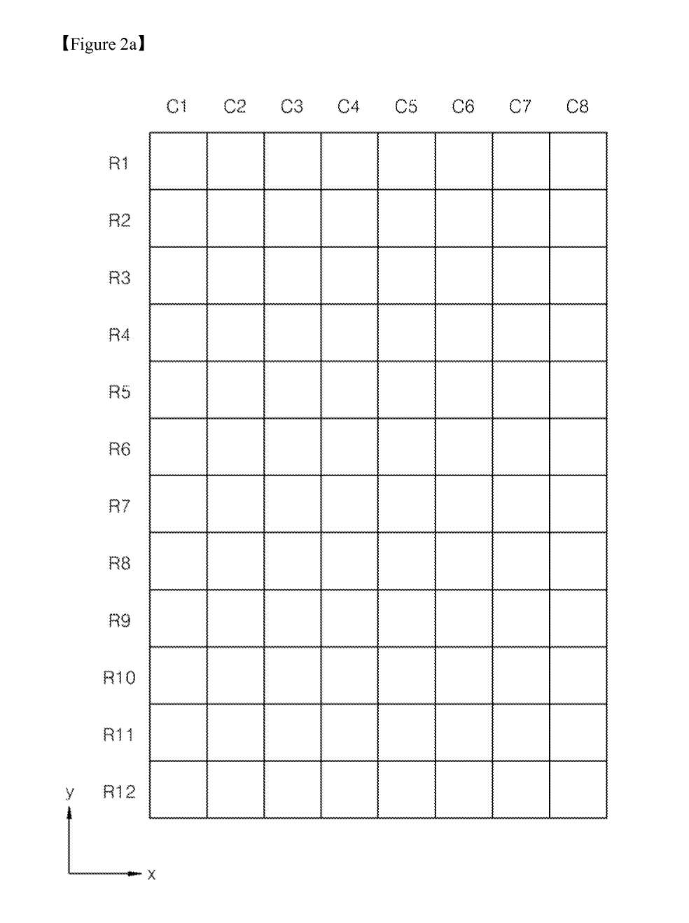

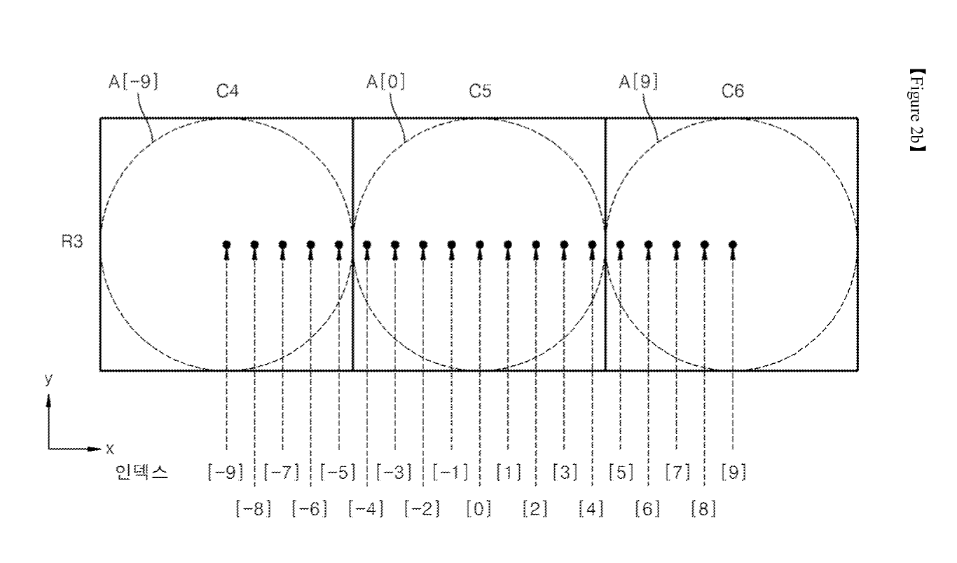

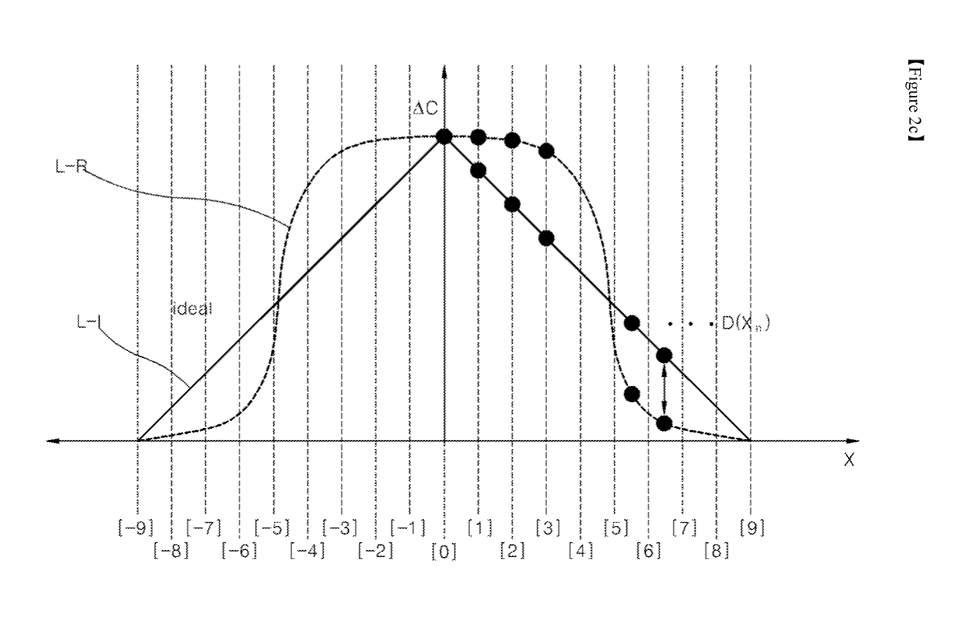

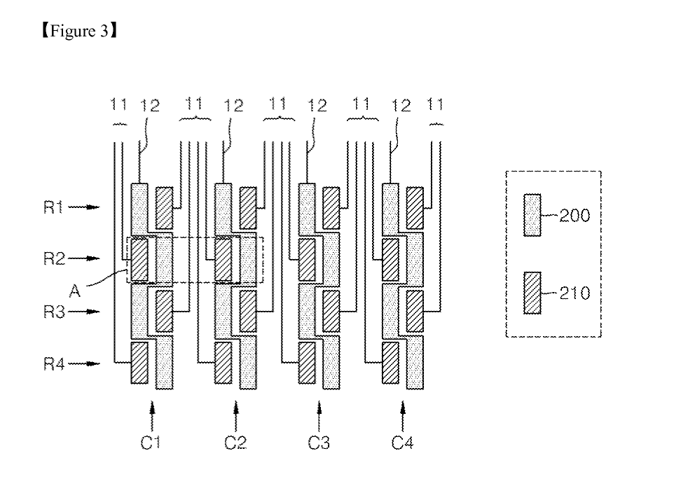

FIG. 2a to FIG. 2c is to explain the capacitance change within a touch node according to the location of the touch center point.

For the convenience of explanation, FIG. 2a describes an exemplary touch panel on which total eight sensing electrodes C1˜C8 and total 12 driving electrodes R1˜R12 are formed. The area for each touch node, where a sensing electrode and a driving electrode overlap, is described with a rectangular shape. In case of being touched by a fingertip, the area, in which the electric field travelling from a driving electrode to a sensing electrode is blocked by the fingertip, can be modeled with an eclipse or circular shape. In this specification, the present invention is explained on the assumption that the above area is modeled by circular shape for the convenience of explanation.

FIG. 2b is a more detailed description of node [R3, C4], node [R3, C5], and node [R3, C6] described in FIG. 2a. A touch input can be provided in such a way that the center of the touch input is located at the point of index of [−9] to [9] described in FIG. 2b. When a touch input is provided such that the touch center point is provided on the point of index [−9], index [0], and index [9], the area where the electric field is blocked can be shown as the circular area A[−9], A[0], and A[9].

The value of the y-axis of FIG. 2c, that is an axis perpendicular to the x-axis, represents a value of capacitance change, and +x-axis and −x-axis respectively represents the distance from the center point of node [R3, C5] to the touch center point towards the right hand direction and the left hand direction. Each of index [−9] to index [9] of FIG. 2c corresponds to each index [−9] to index [9] of FIG. 2b. When a touch input is provided on the node center point of the point indicated by index [0] (that is node [R3, C5]), the y-value reaches the maximum value because the electric field of the node [R3, C5] is blocked the most. On the other hand, if a touch input is provided on the node center point of the point represented by index [−9] (that is, node [R3, C4]) or the node center point of the point represented by index [9] (that is, node [R3, C6]), the y-value becomes zero (0) because the electric fields of node [R3, C5] is not blocked. The straight line L-I illustrated in FIG. 2c represents ideal (i.e. linear) change of capacitance according to the location of touch input (i.e. along the x-axis), and the curved line L-R represents realistic change of capacitance according to the location of touch input. The straight line L-I is ideal one because the calculation complexity for a touch input processor decreases if the capacitance changes linearly with the touch input location. The notation D(xn) illustrated in FIG. 2c represents the difference value between the straight line L-I and the curved line L-R at the point of xn.

In the present invention, the term ‘Interpolability’ is used to define a degree of adequacy for interpolation, and the value for interpolability can be obtained by measuring the change of capacitance according to the above-mentioned distance between two adjacent cells. Equation 1 represents the difference between an ideal interpolation response profile L-I and a realistic interpolation response profile L-R.

$$Interpolability = \frac{n}{\sqrt{{D ( {x}_{1} )}^{2} + {D ( {x}_{2} )}^{2} + … + {D ( {x}_{n} )}^{2}}} \qquad [ Equation 1 ]$$

According to equation 1, if a interpolability shows a lager value, a realistic IRP (Interpolability Response Profile) gets closer to the ideal IRP.

For one embodiment of the present invention, so as to make the IPR have a bigger value, the pattern line of a sensing electrode (i.e. sensing line) and/or the pattern of a driving electrode can be designed to have a density as large as possible. In a touch node, the density of a sensing line determines the distribution profile of fringing capacitance, and the fringing capacitance is proportional to the length of electrode's border line along which a driving electrode faces to a sensing electrode electrically coupled to the driving electrode.

The interpolation response profile illustrated in FIG. 2c have a left-to-right symmetric shape, and such a profile usually appears when each touch node of a touch panel have a pattern which is symmetric for a symmetrical point of the node center point. However, according to a typical configuration of a touch panel, it is not easy to obtain the left-to-right symmetric profile of the interpolation response profile illustrated in FIG. 2c, if the pattern of each node is not symmetrical. If the interpolation response profile is not symmetrical within a touch node, a technical problem may arise that the touch input sensitivity of a touch node is not uniform over the surface of the touch panel.

FIG. 3 illustrates a touch panel according to one embodiment.

FIG. 3 describes a touch panel according to an embodiment where the touch nodes are deployed in 4*4 matrix form. Four sensing electrodes, four driving electrodes, a total of 16 driving traces 11, and a total of four sensing traces 12 are formed on the same layer in this touch panel. A sensing electrode formed in the touch panel may be extended vertically along a column (e.g. C1). The four sensing electrode-cells 200 included in a sensing electrode may be vertically adjacent and directly connected to each other, and in addition, the four sensing electrode-cells 200 can be formed as a unit. A driving electrode formed in the touch panel may be extended horizontally along a row (e.g. R1). The four driving electrode-cells 210 included in a driving electrode may be separated from each other by sensing electrodes. But a driving electrode can be formed only if the separated four driving electrode-cells 210 are electrically connected to each other. Therefore, to do this, driving traces 11 (i.e. the second traces) can be connected to each of the driving electrode-cells 201 respectively, and each of the driving traces 11 may be extended to the outside of a so-called ‘sensing area’ which is the area occupied by the whole driving and sensing electrodes. In the embodiment of the FIG. 3a, a total of 16 driving traces 11 are provided because a total of 16 driving electrode-cells 210 are disposed in a touch panel. The driving traces 11 can be provided in various ways different from the drawings attached to this specification. The four driving traces 11 connected to the driving electrode-cells 210 included in the same row (i.e. in the same driving electrode) can be connected to each other with a first driving trace provided out of the sensing area. The first driving traces and the second driving traces explained above can be connected to each other in various ways.

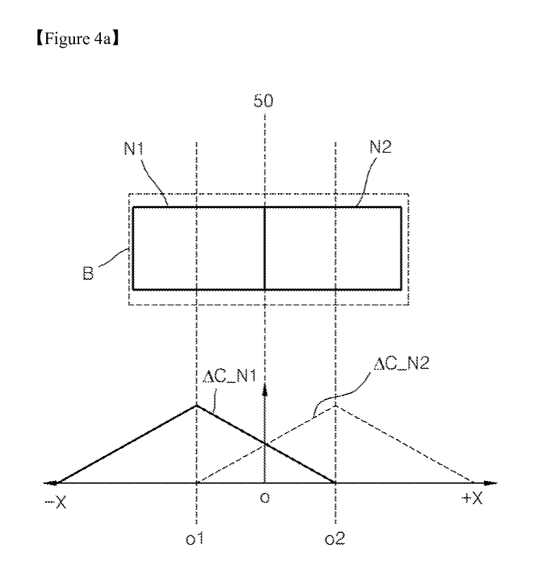

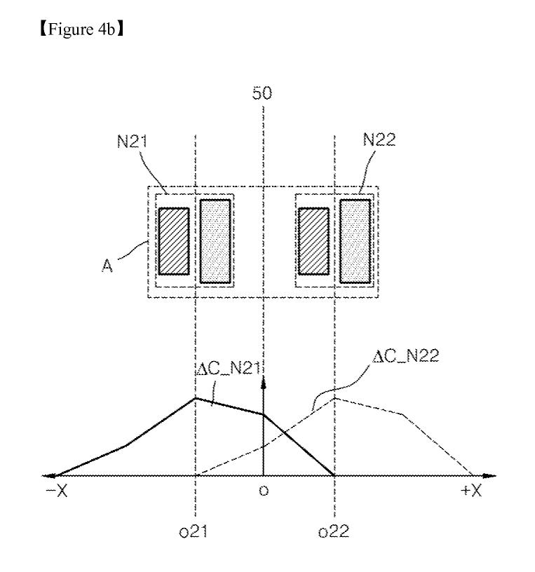

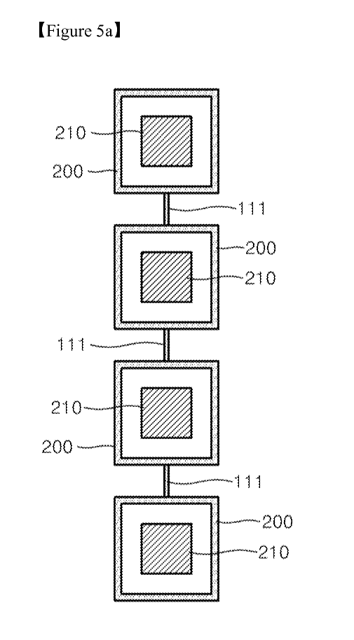

FIG. 4a and FIG. 4b are to explain the asymmetric characteristic of a touch input for a touch input gesture.

FIG. 4a illustrates an ideal capacitance changes ΔC_N1 and ΔC_N2 of touch nodes N1 and N2 according to the x-axis location of the touch center point of a fingertip, in the area B in which two touch nodes N1 and N2 adjacent in the direction of x-axis (i.e. left-to-right) are included. For the convenience of explanation, it is assumed that the diameter of the touch area covered by a fingertip is not larger than the width of each touch node N1 or N2. When the touch center point by a fingertip is located on the node center point o1 of the touch node N1, the capacitance change ΔC_N1 of the touch node N1 becomes the maximum and the capacitance change ΔC_N2 of the touch node N2 becomes the minimum. And, when the touch center point of a fingertip is located on the node center point o2 of the touch node N2, the capacitance change ΔC_N1 of the touch node N1 becomes the minimum and the capacitance change ΔC_N2 of the touch node N2 becomes the maximum. In addition, when the touch center point by a fingertip is located on the center of the border line between the touch node N1 and N2, the capacitance change ΔC_N1 of the touch node N1 and the capacitance change ΔC_N2 of the touch node N2 become substantially the same. The above explanation is based on an ideal situation that the two adjacent touch nodes have a symmetric pattern with a symmetry line of the border line between them. However, such an ideal graph of FIG. 4a cannot be obtained if the two touch nodes N21 and N22 are not symmetric with the axis of the border line 50 between the two touch nodes N21 and N22 as illustrated in FIG. 4b.

FIG. 4b illustrates the capacitance change ΔC_N21 and ΔC_N22 of the touch nodes N21 and N22 according to the x-axis location of the touch center point of a fingertip, when the sensing electrode-cell and the driving electrode-cell have the shape illustrated in the area A of FIG. 3. When the driving/sensing electrode-cells in the touch node N21 are not symmetric for the axis of the border line between them, the capacitance change profile of the touch node N21 according to the x-axis location of the touch center point of a fingertip may not be symmetric for the node center point o21 of the touch node N21. The same explanation is applied to the touch node N22. As a result, when the touch center point of a fingertip is located on the center o of the border line between the touch node N21 and N22, the capacitance change ΔC_N21 of the touch node N21 does not coincide with the capacitance change ΔC_N22 of the touch node N22. When the touch input characteristic is not ideal as illustrated in FIG. 4b, a problem arises that the exact point of a touch input is not easy to calculate. Embodiments of the present invention to solve this problem are explained below.

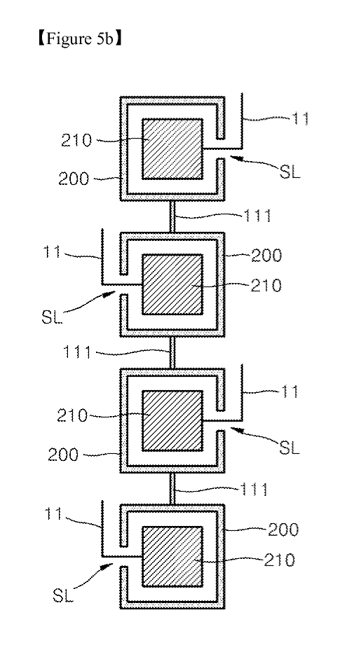

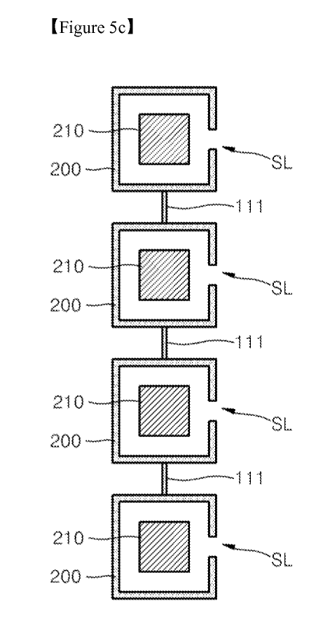

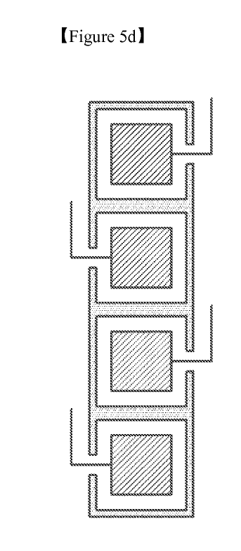

FIG. 5a is to explain the principle for making the patterns for a sensing electrode-cell 200 and a driving electrode-cell 210 according to embodiments of the present invention. Basically, a sensing electrode-cell 200 envelops the up-down-left-right side of the driving electrode-cell 210 which is electrically coupled to the sensing electrode-cell. It is desired that each driving electrode-cell 210 itself is formed to have an exact or almost up-down-left-right symmetrical shape. The sensing electrode-cells 200 included in a sensing electrode can be vertically connected to each other with transparent conductive lines 111. At here, the conductive lines 111 may be made of the same material of the sensing electrode-cells 200, and the conductive lines 111 and the sensing electrode-cells 200 may be formed as a unit. For an embodiment for which a touch panel has an outer boundary with rectangular shape, outer edge of each sensing electrode-cells 200 may have a shape corresponding to the rectangular shape. In addition, inner edge of each sensing electrode-cells 200 may have a shape corresponding to the shape of outer edge of the driving electrode-cell 210 which is electrically coupled to the sensing electrode-cell. By the way, each of driving traces as shown in FIG. 3 should be respectively connected to each driving electrode-cells 210 because sensing electrode-cells 200 and driving electrode-cells are disposed in the same layer of the touch panel, and the driving electrode-cells in the same driving electrode should be connected to each other. Therefore, a slit SL should be formed at a part of a sensing electrode-cell 200 as shown in FIG. 5b and FIG. 5c. The width of the slit SL may have a dimension such that a driving trace can pass through it.

FIG. 5b is to explain the shape and location of sensing electrode-cells 200, driving electrode-cells 210, and driving traces 22 according to one embodiment of the present invention. Basically, the pattern shown in FIG. 5a is used for FIG. 5b, and a slit SL is formed at a sensing electrode-cell 200 in such a way that a driving trace can pass through the slit SL. The driving trace 22 is connected to the driving electrode-cell 210 through the slit SL. The four sensing electrode-cells 200 which are vertically interconnected may be included in one sensing electrode. The slits SL formed at the vertically interconnected sensing electrode-cells 200 may be formed in a left-to-right interlaced way along the sensing electrode's extended direction.

FIG. 5c illustrates an example modified from the pattern shown in FIG. 5b, where the slits SL are formed only at the right side of the sensing electrode-cells 200. However, in other embodiments, the slits SL may be formed only at the left side of the sensing electrode-cells.

FIG. 5d shows another example modified from the pattern illustrated in FIG. 5b. As shown in FIG. 5d, if the vertically adjacent sensing electrode-cells 200 are very closely adjacent to each other and connected directly to each other, the parts corresponding to the conductive lines 111 of FIG. 5b can be omitted.

When the sensing electrode-cells are observed separately from other parts in FIG. 5d, it can be understood that the sensing electrode-cells are in form of a ladder (i.e. ladder shape), and several slits are formed at several point of the sensing electrodes. That is, the touch panel according to one embodiment of the present invention is a touch panel where the driving electrodes and the sensing electrodes are formed in the same layer, and the sensing electrode is in the form of a ladder shape, and the up-down-left-right side of a driving electrode-cell is enveloped by a sensing electrode which is electrically coupled to the driving electrode-cell, and a plurality of slits are formed at a plurality of points of a sensing electrode, and a plurality of driving traces are connected to a plurality of driving electrode-cells through the slits, respectively.

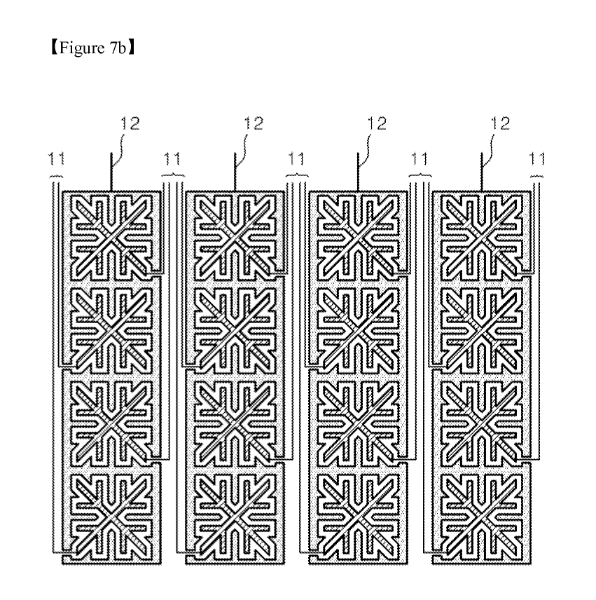

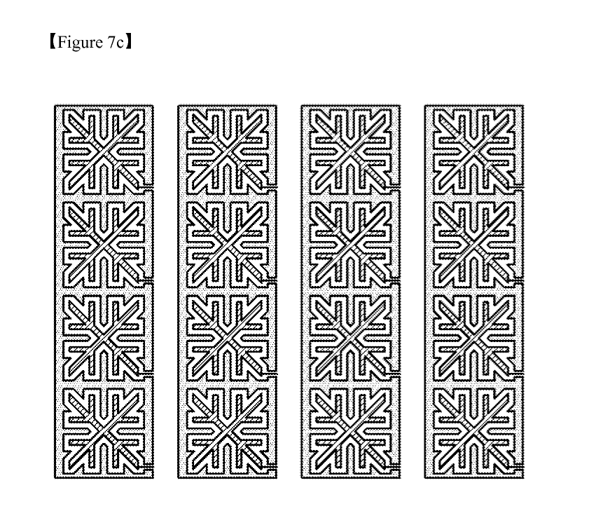

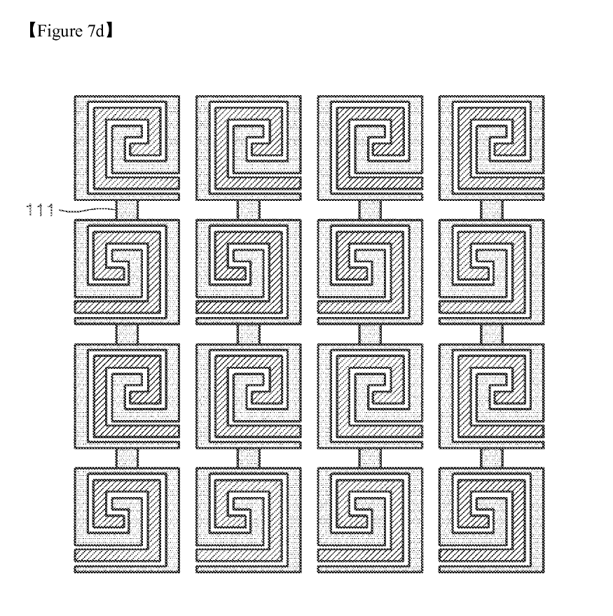

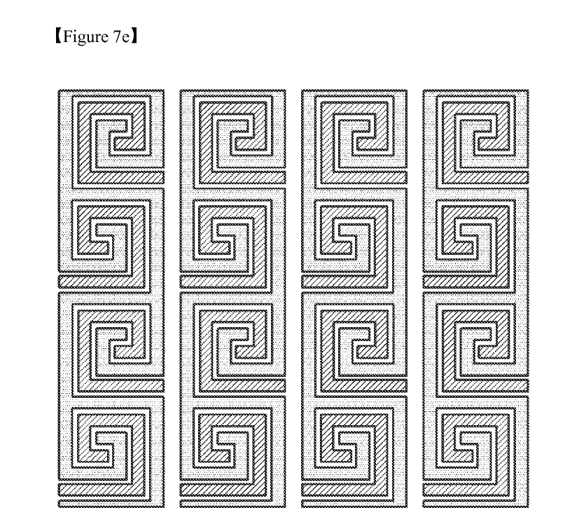

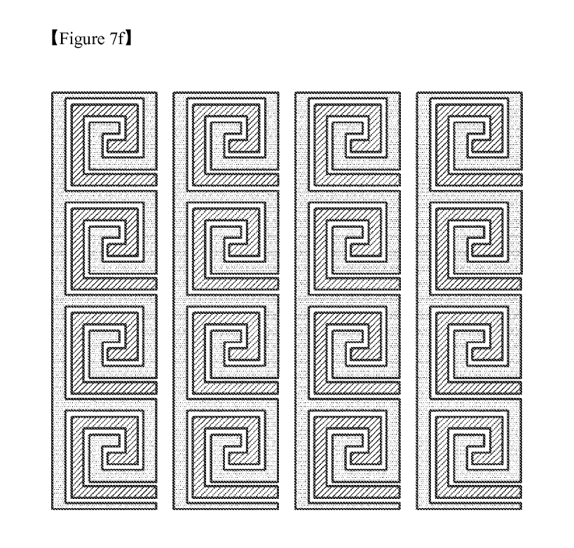

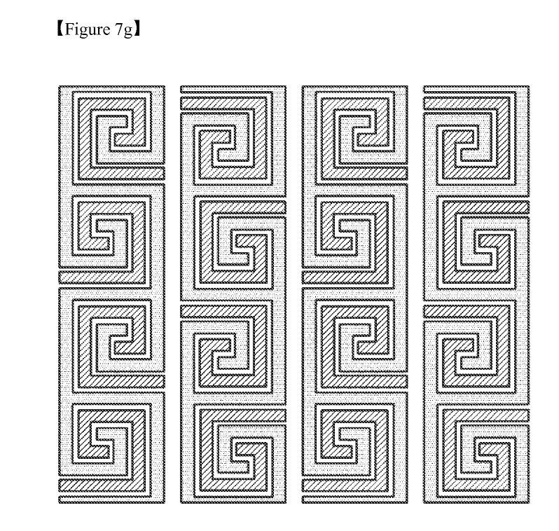

When observing the sensing electrode-cells separately from other parts of the basic structure shown in FIG. 5a to FIG. 5c, it can be understood that the sensing electrode-cells are in the same form as the ladder form in FIG. 5d. Such a structure can be modified to the patterns as shown in FIG. 7a to FIG. 7g below.

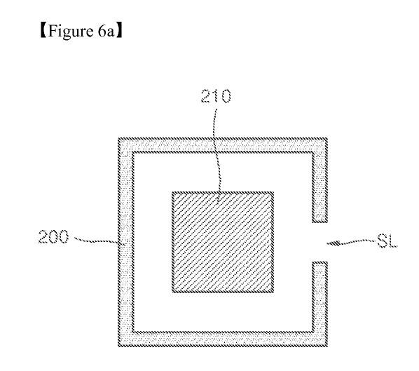

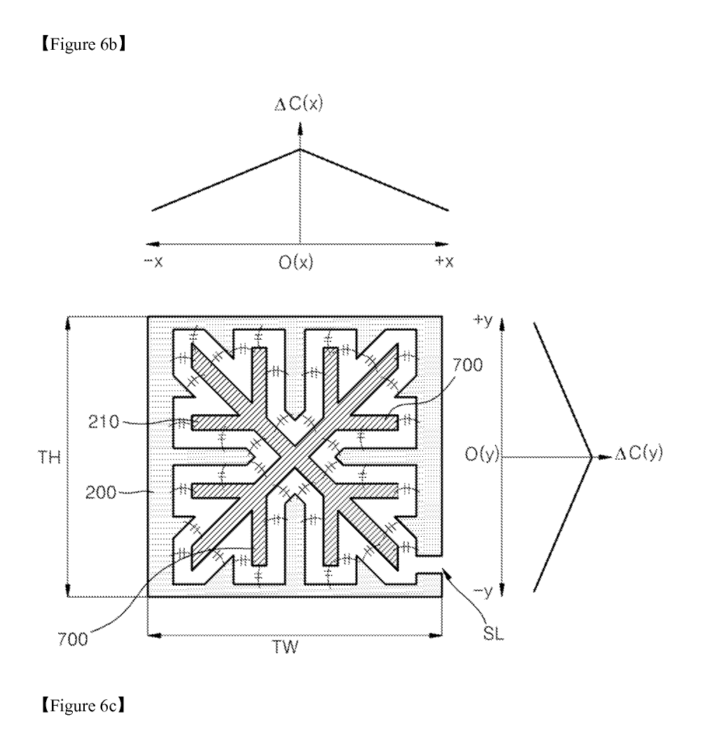

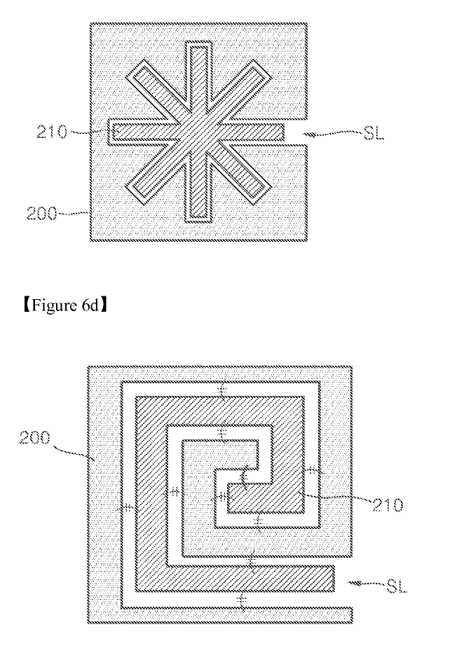

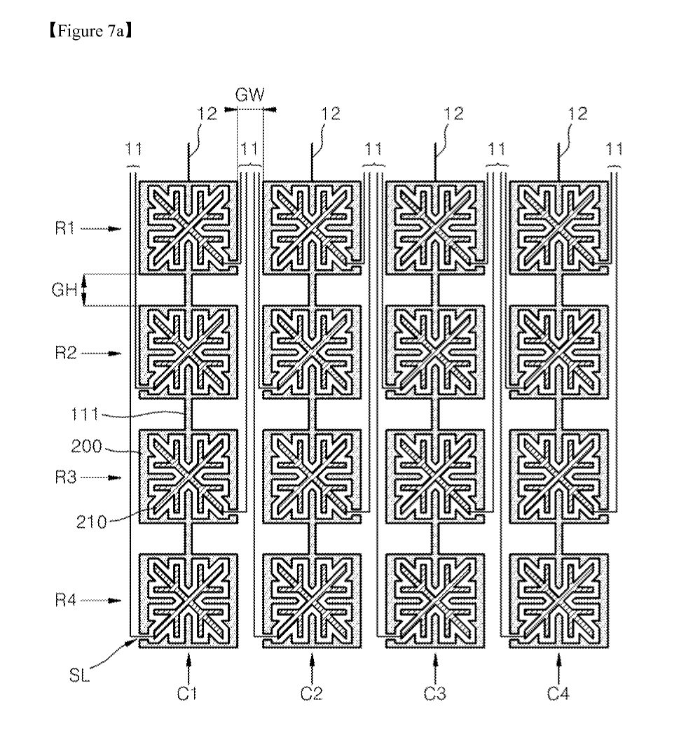

FIG. 6a to FIG. 6d illustrates various shapes of a touch node according to various embodiments of the present invention.

For the touch node shown in FIG. 6a to FIG. 6c, a sensing electrode-cell 200 envelops the up-down-left-right side of a driving electrode-cell 210, and each of the sensing electrode-cell 200 and the driving electrode-cell 210 itself has a symmetrical shape. But, a slit is formed at the sensing electrode-cell 200, through which the above mentioned driving trace passes. Particularly, when a driving electrode-cell 210 and a sensing electrode-cell 200 have a plurality of branches 700 as shown in FIG. 6b, the fringing capacitance element that influences the sensitivity of a touch input can be distributed evenly over the whole area of a touch node. In result, the capacitance change ΔC(x) and ΔC(y) of a touch node according to the location of the touch center point of a fingertip can be adjusted such that each of the capacitance change ΔC(x) and ΔC(y) are symmetric with a symmetrical point of the node center point O(x) and O(y) of the touch node. The above explanation can be applied to the pattern shown in FIG. 6c in the same way. The shape of the touch node shown in FIG. 6b can be obtained by modifying the basic shape of the touch node shown in FIG. 6a.

In the touch node shown in FIG. 6d, the sensing electrode-cell 200 and the driving electrode-cell 210 themselves are not symmetric. However, except the part of the slit SL, the sensing electrode-cell 200 envelops the up-down-left-right side of the driving electrode-cell 210, and because each of the sensing electrode-cell 200 and the driving electrode-cell 210 has a long-thin-whirly pattern, the fringing capacitance element which influences the touch input sensitivity can be distributed evenly over the whole area of the touch node. Therefore, the pattern of FIG. 6d can show a similar effect of the pattern shown in FIG. 6b.

FIG. 7a shows a structure of a touch panel according to one embodiment of the present invention.

FIG. 7a shows a touch panel according to one embodiment of the present invention, especially a touch panel with a four by four matrix structure. This touch panel includes 16(=4*4) touch nodes. The pattern of each touch node is the same as the pattern shown in FIG. 6b, while the pattern of the touch nodes included in the first row (e.g. R1) has the form that can be obtained by flipping the pattern of the touch nodes included in the second row (e.g. R2) in left-to-right direction. Each of the driving electrodes R1 to R4 includes four driving electrode-cells 210, and each of the sensing electrodes includes four sensing electrode-cells 200. The four sensing electrode-cells included in one sensing electrode (e.g. C1) are vertically interconnected with the conductive lines 111 (for example, transparent conductive lines). Because the sensing electrodes C1 to C4 and the driving electrodes R1 to R4 are disposed in the same layer, the four driving electrode-cells 210 included in one driving electrode cannot be interconnected in a manner of traversing a sensing electrode horizontally, instead, the four driving electrode-cells 210 can be interconnected with the driving traces 11 at the outside of the touch panel, while each of the driving traces 11 extends to the outside of the sensing area where the sensing electrode-cells 200 and the driving electrode-cells 210 are disposed.

FIG. 7b illustrates a modified embodiment where the elements corresponding to the conductive lines 111 of FIG. 7a are omitted and the sensing electrode-cells are directly connected to each other in vertical direction.

The pattern according to FIG. 7a has a technical feature different from that of FIG. 7b. For the pattern shown in FIG. 7a, driving traces 11 should be disposed between two adjacent sensing electrodes, and the two adjacent sensing electrodes should have a predetermined gap (i.e. space) GW between them for the driving traces 11. In this situation, it is desired to configure such that the touch input characteristic along the vertical direction of a touch panel is similar to that along the horizontal direction of the touch panel. Therefore, as a corresponding feature to the horizontal-gap GW formed between two horizontally adjacent sensing electrodes, it can be configured such that two vertically adjacent driving electrodes (i.e. driving electrode-cells) are separated by a predetermined vertical-gap GH. At here, the ratio of the vertical gap GH to the horizontal gap GW may be the same as the ratio of the top-to-bottom width TH to the left-to-right width TW of a touch node for one embodiment. Or, the ratio of the vertical gap GH to the horizontal gap GW may be determined to be 1:1 in another embodiment. Above explanation can be applied to FIG. 7d to FIG. 7e in the same way.

FIG. 7c shows a modified embodiment where the patterns of the touch nodes included in the second row R2 and the fourth row R4 of the touch panel shown in FIG. 7b are flipped horizontally. FIG. 7c is an embodiment where driving traces 11 are not shown just for the simplicity of the explanation, but for a modified embodiment, the vertical gap GH and the driving traces 11 can be inserted to the configuration as shown in FIG. 7a.

The pattern according to FIG. 7c may have a technical feature different from that according to FIG. 7b.

According to the pattern shown in FIG. 7b, the driving traces 11 are disposed in a left-right (i.e. horizontally) interlaced way along the sensing electrode's extended direction for the sensing electrode. Therefore, the driving traces 11 can be deployed evenly over a touch panel, and as a result, it shows an advantageous effect that the unevenness of the touch input characteristic over the touch panel, which is caused by the deployment of the driving traces 11, decreases.

Compared to this, the pattern shown in FIG. 7c provides another advantageous effect that the electric resistance of a sensing electrode which is extended vertically as shown in FIG. 7c is smaller than the electric resistance of a sensing electrode according to FIG. 7b.

The above explanation can be applied to FIG. 7d to FIG. 7f below.

FIG. 7d shows an embodiment modified from FIG. 7a such that each touch node of the touch panel shown in FIG. 7a is substituted by the touch node shown in FIG. 6d.

FIG. 7e shows an embodiment modified from FIG. 7b such that each touch node of the touch panel shown in FIG. 7b is substituted by the touch node shown in FIG. 6d.

FIG. 7f shows an embodiment modified from FIG. 7c such that each touch node of the touch panel shown in FIG. 7c is substituted by the touch node shown in FIG. 6d.

FIG. 7g shows an embodiment modified from FIG. 7d such that the touch nodes of the second column C2 and the fourth column C4 of the touch panel shown in FIG. 7d are flipped over in the vertical and horizontal direction.

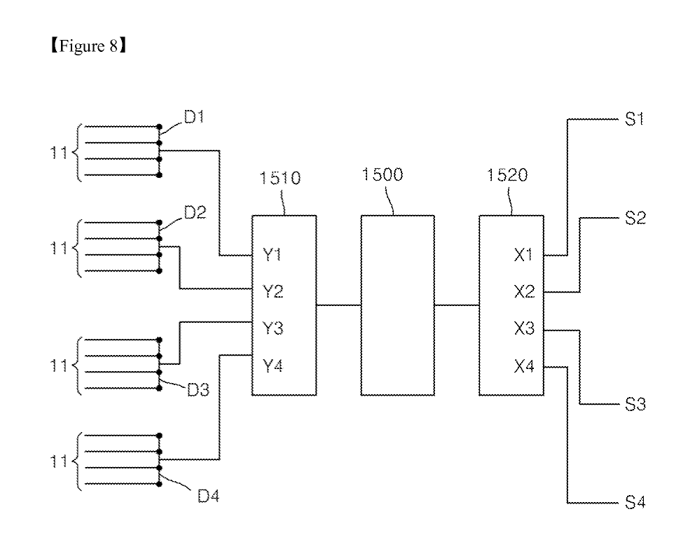

FIG. 8 shows the connection of the driving traces 11 and the sensing traces 12 shown in FIG. 7a at the outside of the sensing area of the touch panel. The four driving traces 11 connected to the driving electrode-cells included in a driving electrode (e.g. R1) can be interconnected with a first driving trace D1 at the outside of the sensing area. The remaining driving electrodes can be interconnected respectively by the first driving traces D2 to D4. However, because different driving electrodes should be electrically separated, insulating layers and/or vias may be used to make a layout for the driving traces and the first driving traces, and details of the layout are not specifically explained in this specification because various configurations for the layout are already disclosed in the related art. Each of four driving electrodes may be connected to a driving signal generating part 1510. The driving signal generating part 1510 can control such that, when a driving signal is applied to a driving electrode (e.g. R1, Y1), the remaining other driving electrodes are kept to a fixed voltage, for example, to a ground voltage. The sensing traces 12 each of which is connected to the sensing electrodes C1 to C4 shown in FIG. 7a can be connected to a driving signal detecting part 1520 directly or through the first sensing traces S1 to S4. The driving signal detecting part 1520 can detect the level of the signal detected at each of the sensing electrode C1 to C4. The level of the detected signal can be changed according to the capacitance formed by the driving electrodes and the sensing electrodes. The touch input detecting part 1500 may be configured to be connected to the driving signal generating part 1510 and the driving signal detecting part 1520, and can determine a specific touch input location.

For the embodiments explained in this specification, a plurality of sensing electrode-cells included in a sensing electrode are interconnected directly in the above mentioned sensing area, and a plurality of driving electrode-cells included in a driving electrode are interconnected substantially at the outside of the sensing area. However, such configurations for the driving electrode and the sensing electrode can be interchanged for another embodiments, for example, a driving electrode-cell may envelop up-down-left-right side of a sensing electrode-cell which is electrically coupled to the driving electrode-cell.

The outer boundary of a touch panel may have a rectangular shape but not restricted to this shape, and a touch panel may have a flat or curved surface. According to the shape of the outer boundary of a touch panel, the shape of a sensing electrode, a driving electrode, a sensing electrode-cell, and a driving electrode-cell can be changed.

Until now preferred embodiments for the present invention has been explained, and it will be apparent to those skilled in the art that various modifications and variations can be made in the present invention without departing from the spirit or scope of the invention.

Thus, above explained embodiments should not be considered as restrictive point of view but be considered as explanatory point of view, and it should be understood that the scope of the present invention is provided by the appended claims and their equivalents.

1. A touch panel, comprising a driving electrode including a plurality of driving electrode-cells and a sensing electrode including a plurality of sensing electrode-cells, wherein,
the driving electrode and the sensing electrode are formed in the same layer of the touch panel,
each of the sensing electrode-cells is configured to envelop up-down-left-right side of each of the driving electrode-cells which is electrically coupled to the each of the sensing electrode-cells, respectively, and
a slit is formed at the each of the sensing electrode-cells to connect a driving trace to the each of the driving electrode-cells.

2. The touch panel of claim 1, wherein, the each of the driving electrode-cell itself has a up-down-left-right symmetric shape, and the each of the sensing electrode-cells itself has a up-down-left-right symmetric shape except the slit.

3. The touch panel of claim 1, wherein, the each of the driving electrode-cells has a first whirling portion extended along a first sense of rotation, and the each of the sensing electrode-cells includes a second whirling portion which is extended along the first whirling portion, respectively.

4. The touch panel of claim 1, wherein,
the [k]-th slit formed at the [k]-th sensing electrode-cell included in the sensing electrode is formed at the left side of the [k]-th sensing electrode-cell, and
the [k+1]-th slit formed at the [k+1]-th sensing electrode-cell included in the sensing electrode is formed at the right side of the [k+1]-th sensing electrode-cell.

5. The touch panel of claim 1, wherein, all of the plurality of slits formed at the plurality of sensing electrode-cells included in the sensing electrode are formed at only one side of the plurality of the sensing electrode-cells.

6. A touch panel comprising a plurality of touch nodes, wherein,
each of the touch node includes a driving electrode-cell and a sensing electrode-cell which is electrically coupled to the driving electrode-cell,
the driving electrode-cell and the sensing electrode-cell are formed at the same layer of the touch panel,
the sensing electrode-cell is configured to envelop up-down-left-right side of the driving electrode-cell which is electrically coupled to the sensing electrode-cell, and
a slit is formed at the sensing electrode-cell to connect a driving trace to the driving electrode-cell.

7. The touch panel of claim 6, wherein, the driving electrode-cell itself has a up-down-left-right symmetric shape, and the sensing electrode-cell itself has a up-down-left-right symmetric shape except the slit.

8. A touch panel comprising a driving electrode and a sensing electrode; wherein,
the driving electrode and the sensing electrode are formed on the same layer of the touch panel,
the sensing electrode has a ladder shape,
a driving electrode-cell which is electrically coupled to the sensing electrode is enveloped up-down-left-right side with the sensing electrode, and
a slit is formed at the sensing electrode to pass a driving trace connected to the driving electrode-cell.
